(19) United States
(12) Patent Application Publication
(10) Pub. No.: US 2021/0298252 A1
(43) Pub. Date: Sep. 30, 2021

(54) NUTRICULTURE SYSTEM

(71) Applicant: PLANTS LABORATORY, INC., Tokyo (JP)

(72) Inventor: Atsuyuki YUKAWA, Tokyo (JP)

(21) Appl. No.: 17/259,385

(22) PCT Filed: Jul. 11, 2019
(86) PCT No.: PCT/JP2019/027527

§ 371 Date: Jan. 11, 2021

(30) Foreign Application Priority Data
Jul. 12, 2018 (JP) 2018-132218

(51) Int. Cl. A01G 31/06; A01G 7/04

(52) U.S. Cl. CPC A01G 31/06; A01G 7/045

(57) ABSTRACT

A problem to be solved by the present invention is to obtain a nutriculture system that can manage a growth environment of a plant in accordance with the state of the plant, to thereby produce good quality vegetables and fruits with low production costs. The nutriculture system (100) of the present invention is a nutriculture system for cultivating plants (10) using a nutrient solution (L). The nutriculture system comprises: a growth section (110) configured for growing the plants; a nutrient solution tank (131) configured for containing the nutrient solution; a measurement section (140) configured for measuring the concentration of at least one of a plurality of ions contained in the nutrient solution; and a control section configured for controlling the growth environment of the nutriculture system based on change in a measured value of the ion concentration.

### FIELD OF THE PRESENT DISCLOSURE

The present invention relates to a nutriculture system for properly managing growth environment of a plant according to a change in ion concentration of a nutrient solution.

### BACKGROUND OF THE PRESENT DISCLOSURE

In recent years, nutriculture has become increasingly popular. The reason is that the nutriculture can produce vegetables, fruits and other crops in large quantities with good efficiency and constant quality.

However, in the nutriculture, the ion concentration management of the nutrient solution is important, and the ion concentration management of the nutrient solution has been carried out by determining the conductivity of the nutrient solution.

For example, Patent literature 1 discloses a technology for separately determining the concentration of all types of ionic components contained in a nutrient solution using an ion meter capable of separately determining the concentration of specific ions in the nutrient solution, and replenishing insufficient ionic components.

### PRIOR ART LITERATURE

### Patent Literature

Patent literature 1: Japanese Patent Laid-Open Publication No. 6-253695

### SUMMARY OF THE PRESENT DISCLOSURE

### Problems to be Solved by the Invention

The inventor has found that although such management of the concentration of specific ions in a nutrient solution is performed in the conventional nutriculture, the management of growth environment (e.g., the amount of light to the plant, the temperature or humidity of the ambient gas in which the plant is placed, or the concentration of various ions in the nutrient solution, etc.) of the plant is performed uniformly based on change of the day's sunshine time, air temperature and humidity, which are different from season to season. This management for the growth environment cannot be adapted to the management of the state of the plant.

The invention aims to obtain a nutriculture system capable of managing appropriate growth environment of the plants in coordination with the state of the plant and inhibiting the production cost to be low and efficiently producing high-quality vegetables and fruits.

### Measures Taken to Solve the Problems

The invention provides the following solution.

(Solution 1)

A nutriculture system for cultivating plants by utilizing a nutrient solution comprises:
a growth section configured for growing the plant;
a nutrient solution tank configured for containing the nutrient solution;
a measurement section configured for measuring the concentration of at least one ion contained in the nutrient solution;
a control section configured for controlling growth environment of the nutriculture system based on a change in a measured value of the ion concentration; and
a supply unit configured for supplying the ions to the nutrient solution tank.

(Solution 2)

In the nutriculture system according to the solution 1, the growth environment is selected from a concentration of the ions supplied by the supply unit, an amount of light irradiated to the plants, a temperature, an air speed, an air volume, and a humidity.

(Solution 3)

In the nutriculture system according to the solution 1 or 2, the control section controls an environment forming unit and/or the supply unit based on the measured amount or rate of change of concentration of the at least one ion over a prescribed period.

(Solution 4)

In the nutriculture system according to any one of the solutions 1-3, the at least one ion is a phosphorus ion.

(Solution 5)

In the nutriculture system according to any one of the solutions 1-4, the at least one ion further comprises at least one of potassium ions, nitrogen ions, calcium ions, magnesium ions, iron ions, sodium ions, chloride ions, tin ions and molybdenum ions.

(Solution 6)

In the nutriculture system according to any one of the solutions 1-5, the prescribed period is 10 minutes, 30 minutes, 1 hour, 2 hours, or 1 day.

(Solution 7)

In the nutriculture system according to any one of the solutions 1-6,
the measurement section comprises:
a measurement tank configured for containing the nutrient solution taken out of the nutrient solution tank; and
one or more ion selective electrodes arranged in the measurement tank and configured for respectively reacting with the at least one ion.

(Solution 8)

In the nutriculture system according to the solution 7, all or part of the nutrient solution contained in the measurement tank is not returned to the nutrient solution tank, but is discarded.

(Solution 9)

In the nutriculture system according to any one of the solutions 6-8, a measurement tank is provided separately for each of the at least one ion to be measured.

(Solution 10)

In the nutriculture system according to any one of the solutions 6-9, the at least one ion selective electrode comprises at least zinc phosphate selectively reacting with the phosphorus ions contained in the nutrient solution.

(Solution 11)

In the nutriculture system according to any one of the solutions 6-10, the at least one ion selective electrode is a cartridge.

(Solution 12)

In the nutriculture system according to any one of the solutions 1-11, the supply unit is provided with at least one supply tank separately containing the at least one ion.

(Solution 13)

The nutriculture system according to any one of the solutions 1-12, the system further comprises a circulation section configured for circulating the nutrient solution between the plant and the nutrient solution tank.

(Solution 14)

In the nutriculture system according to claim 12 or 13, the at least one supply tank is a cartridge.

(Solution 15)

A manufacturing method for cultivating plants by a nutrient solution comprises a process for cultivating the plants by using the nutriculture system according to any one of the solutions 1-14.

### Effects of the Invention

According to the present invention, it is possible to obtain a nutriculture system capable of managing growth environment of a plant in coordination with the state of the plant, thereby being capable of inhibiting the production cost to be low and efficiently producing high-quality vegetables and fruits.

### BRIEF DESCRIPTION OF THE DRAWINGS

FIG. 1 is a diagram for explaining a nutriculture system 100 of Embodiment 1 of the present invention.

### DESCRIPTION OF THE EMBODIMENTS

The invention will now be described, by way of example, with reference to the accompanying drawings as required. It should be understood that, throughout this specification, the expression of singular forms also includes its plural forms unless it is specifically stated. Furthermore, it should be understood that the terms used in the specification are intended to have the meanings commonly used in the art, unless otherwise indicated. Accordingly, unless otherwise defined, all technical and scientific terms used in this specification have the same meaning as commonly understood by one of ordinary skill in the art to which this invention belongs. In case of conflict, the present specification, including definitions, will prevail.

The present invention is directed to the correlation between changes in the amount of ions in a nutrient solution absorbed by a plant per hour during the nutriculture and the growth state of the plant. Thus, the inventor of the present invention finds the following conditions. The growth environment of the cultivation system is controlled based on a change (e.g., a change amount or a change rate) within a prescribed period of a measured value of a concentration of at least one of a plurality of ions contained in the nutrient solution, where by cultivation of plants in the nutriculture system can be effectively performed. Further, it should be noted that, in the present invention, in the case of what is referred to as “a measured value of ion concentration”, it refers to a value directly measured by a measurement unit of ion concentration, rather than a value indirectly derived from a measured value of other ions by calculation or deduction, etc.

Therefore, in the present invention, the growth environment is controlled to be an environment suitable for the growth state of the plant based on the change in the measured value of the concentration of at least one ion contained in the nutrient solution supplied to the plant.

While not intending to be bound by theory, in addition to the day and night, and seasons, there may be a growth phase in which photosynthesis is performed and nutrients are absorbed from the nutrient solution, and a resting phase in which absorption of nutrients are reduced while the growth is stopped or slowed down, even during a day. It is considered that plants do little photosynthesis and nutrient absorption in the resting phase. However, the existing nutriculture system also supplies the same nutrients and light as the growth phase in this resting phase, which is inefficient. The invention finds and solves the problem of low efficiency of the existing nutriculture system.

That is, the present invention can determine which stage a plant is in a plurality of cultivation stages, which has not been made by the conventional nutriculture system, and adjust the growth environment in coordination with the growth state in each cultivation stage based on the determination result. In the present invention, the so-called “growth environment” may include, but is not limited to, an irradiation amount of light to a plant, a temperature, a carbon dioxide concentration, an air speed, an air capacity, a humidity, an ion concentration of each ion in a nutrient solution, an electrical conductivity (EC), a pH, etc. By the adoption of the structure, the growth environment can be correctly and properly adjusted in cooperation with the growth stage of the plants, the effective growth of the plants can be realized, and the production cost of the plants can be reduced due to the efficient growth of plants and by saving photothermal cost and nutrient solution cost.

As long as the problem of the present invention can be solved, one or more ions contained in the nutrient solution, the growth section, and the nutrient solution tank for cultivating the plants are not particularly limited.

The one or more ions to be measured may be any ion required for the growth of the plants. The ions to be measured may be, but are not limited to, for example, nitrogen (N: nitric acid, ammonia), phosphorus (P), boron, potassium (K), calcium (Ca), magnesium (Mg), sulfur (S: sulfuric acid), iron (Fe), copper (Cu), manganese (Mn), molybdenum (Mo), zinc (Zn), chlorine (CI: chlorides) and the like. Especially preferably, nitrogen (N), phosphorus (P), potassium (K) and calcium (Ca) referred to as three elements of fertilizer are measured. In a representative embodiment, in the present invention, the ion concentration of phosphorus (P) can be measured directly using a measuring instrument (e.g., an electrode).

Further, the growth section for growing the plant is a mechanism for enabling the plant to grow by supplying a nutrient solution, and may be any mechanism as long as there is a mechanism for forming the growth environment for the plant. Among other things, the unit for forming the growth environment of the plant may be, for example, a supply unit for supplying ions, an illumination instrument or sunlight for irradiating light to the plant, a temperature regulator configured for regulating the temperature of ambient air around the plant, an air speed and air capacity regulator configured for regulating air speed and/or air capacity of an air supply fan for supplying air to the ambient air around the plant, a humidity regulator configured for regulating the humidity of the ambient gas around the plant, and a carbon dioxide concentration regulator configured for regulating the concentration of carbon dioxide of the ambient gas around the plant, etc. However, the present invention is not limited thereto. In the present specification, the “environment forming unit” refers to an illumination instrument or sunlight which irradiates light to the plant, a temperature regulator which regulates the temperature of ambient air around the plant, a humidity regulator which regulates the humidity of the ambient air around the plant, and an air speed and air capacity regulator which regulates the air speed and/or air capacity of an air supply fan for supplying air to the ambient air around the plant, and/or a carbon dioxide concentration regulator which adjusts the concentration of carbon dioxide of the ambient gas around the plant.

As to the measurement section, it is not particularly limited as long as the concentration of ions contained in the nutrient solution can be measured. With regard to the nutriculture system of the present invention, it is preferable to have one sensor respectively corresponding to each ion so that concentration of one or more ions contained in the nutrient solution can be separately (individually) measured.

The sensor may be any sensor capable of separately determining the range of each ion, for example, a well-known ion selective electrode that reacts with each ion. For example, as an ion selective electrode capable of directly determining phosphorus ions, a zinc phosphate electrode may be used. However, the present invention is not limited thereto, and may be, for example, a spectrometer sensor.

Further, the ion selective electrode is preferably a cartridge. By the adoption of the cartridge, efforts needed for replacing the electrodes and corrections of the sensors needed for replacing the electrodes can be saved, and the production cost can be reduced. In this case, for example, an insertion portion of an electrode cartridge is provided in a nutrient solution tank, and the electrode cartridge is inserted in the insertion portion to measure the concentration of an ion as a subject using an electrode.

As for the supply unit for supplying at least one or more kinds of ions to the nutrient solution tank, any structure is possible as long as one or more kinds of ions can be supplied, but it is preferable that a supply tank is provided for each kind of ions so that each kind of ions can be supplied separately. By providing each ion with a separate supply tank, only required ions can be supplied, so that unnecessary supply of nutrient solution can be avoided, and production cost is reduced. In addition, since the required ions can be supplied separately, functional vegetables such as vegetables rich in iron components (iron ions), calcium components, and the like can also be efficiently cultivated.

Further, preferably, the supply tank is a cartridge. By adopting the cartridge, the replacement can be facilitated, and the cost can be reduced.

In general, depending on whether a plant is subjected to photosynthesis during an initial stage of growth such as germination of the plant, an intermediate stage of growth such as flowering, a final stage of growth such as fruiting, etc., or whether the plant is subjected to photosynthesis during daytime, nighttime, etc., required or proper nutrition, the amount of light received by the plant, the temperature around the plant, and the humidity around the plant may vary. In the present invention, the control section considers one or more of these factors as a parameter, while the growth environment of the plant in the system is further controlled according to the change in ion concentration.

In addition, in the present specification, the “growth stage” of a plant refers to an initial stage of growth such as germination of the plant, an intermediate stage of growth such as flowering, a final stage of growth such as fruiting, etc., which can be determined according to the outside and appearance of the plant. In contrast, the “cultivation stage” of a plant refers to a growth phase (a period in which photosynthesis is performed, and nutrition is absorbed from a nutrient solution even during a day, besides day and night and seasons), a resting phase (a period in which growth is stopped or slowed down by reducing absorption of nutrients), or a period in which it is suitable for absorbing specific ions while the state of the plant cannot be determined according to the outside and appearance of the plant.

The control section is provided with an operation section which can determine the cultivation stage of the plant according to the change of the ion concentration. A correlation relation between the change of the ion concentration and the cultivation stage is input in advance in the operation section so as to calculate the change of the measured ion concentration and determine the cultivation stage according to the result. Depending on the stage of cultivation determined, the control section may alter the growth environment of the plant, if necessary or preferred. By adopting this structure, the nutriculture system of the present invention can determine the state of the plant according to the change of the ion concentration, and manage the appropriate growth environment of the plant in coordination with the obtained state of the plant.

In addition, each control condition of the environment forming unit that forms a desired growth environment according to the determined cultivation stage may be registered in the operation section.

Any plant can be cultivated using the nutriculture system of the present invention. The plants cultivated by the nutriculture system of the present invention are preferably perennial plants. The perennial plants refer to plants that can be harvested for many consecutive years once cultivated. A perennial plant has a longer cultivation period than an annual plant and is greatly affected by the change in the ion concentration of the nutrient solution during cultivation. Therefore, during the cultivation of perennial plants, it is particularly preferable to utilize the nutriculture system of the present invention for proper growth environment management of plants matching the state of the plants. As examples of perennial plants, fruits such as strawberries, watermelons and the like, vegetables such as tomatoes, potatoes, green onions and the like can be cited, but the present invention is not limited thereto. For example, it may also be an annual plant of lettuce or the like.

In the following description of the embodiments, the nutrient solution, as a liquid containing phosphorus ions, nitrogen ions and potassium ions, is a liquid obtained by mixing a nitric acid solution, a phosphoric acid solution and a potassium chloride solution. In the nutrient solution, the phosphorus ions are in the state of phosphate ions, the nitrogen ions are in the state of nitrate ions, and the potassium ions are in the state of potassium ions.

Further, in the following embodiment, the change in the ion concentration measured by the measurement section is calculated by a processor built in a computer. In an embodiment, when the measurement section repeatedly measures the concentration of each ion in the nutrient solution at prescribed intervals of about 10 minutes to about 60 minutes, the processor calculates a change (e.g., the amount or rate of change, etc.) in the ion concentration for each prescribed period (e.g., every 30 minutes), and determining whether the calculated change is a vigorous growth phase with such as photosynthesis or a resting phase with such as less nutrient absorption according to the correlation relation between the change of the ion concentration and the cultivation stage previously input into the calculation section. However, the calculation of the change of the ion concentration may also be performed by a computer-independent computing device.

The following embodiments are provided for a better understanding of the present invention, and the scope of the present invention should not be limited to the following description. It will be obvious to a person skilled in the art that appropriate changes can be made within the scope of the invention with reference to what is described in the specification.

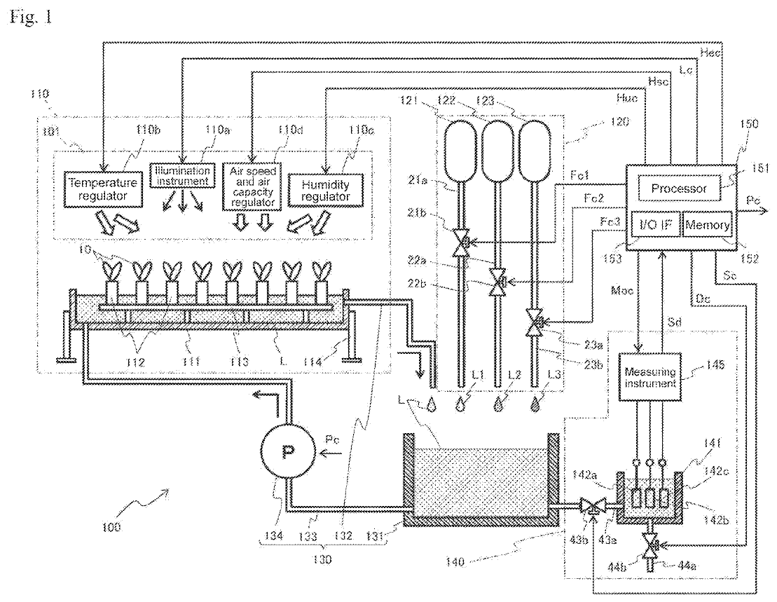

FIG. 1 is a diagram for explaining a nutriculture system 100 of Embodiment 1 of the present invention.

The nutriculture system 100 shown in FIG. 1 is a nutriculture system for cultivating plants 10 by using a nutrient solution L. The nutriculture system 100 comprises: a growth section 110 configured for growing the plant 10; a nutrient solution circulation section 130 which circulates the nutrient solution L between the plant 10 and the nutrient solution tank 131; and a measurement unit 140 that measure the concentration of at least one of a plurality of ions contained in the circulated nutrient solution L. The growth section 110 has an environment forming unit 101 configured for forming growth environment of the plant 10.

Further, the nutriculture system 100 includes: a fertilizer supply section 120 which supplies various fertilizer solutions constituting the nutrient solution L to a nutrient solution tank 131 of a nutrient solution circulation section 130; and a control section (computer) 150 that controls the environment forming unit 101 according to the measured change in the concentration of at least one ion so that the growth environment becomes an environment suitable for the cultivation stage of the plant 10.

Hereinafter, description will be made in more detail.

(Growth Section 110)

The growth section 110 has a plurality of cultivation pots 112 configured for accommodating the plants 10; and a cultivation box 111 configured for accommodating a plurality of cultivation pots 112. A pot holding table 113 for holding the plurality of cultivation pots 112 is provided in the cultivation box 111, and the cultivation box 111 is configured such that, when the nutrient solution is filled inside the cultivation box 111, a lower portion of the cultivation pot 112 placed on the pot holding table 113 is immersed in the nutrient solution L.

In addition, the cultivation box 111 is installed with box supporting feet 114, and the cultivation box 111 is maintained at a prescribed height from a setting surface by the box supporting feet 114.

Further, the growth section 110 includes an environment forming unit 101 having an illumination instrument 110a which irradiates light to the plant 10 accommodated in the cultivation box 111; a temperature regulator 110b that regulates a temperature of the ambient gas around the plant 10; a humidity regulator 110c that regulates a humidity of the ambient gas around the plant 10; and an air speed and air capacity regulator 110d which regulates the air speed and/or air capacity of a blowing fan for blowing the ambient air toward the periphery of the plant. The illumination instrument 110a, the temperature regulator 110b, the humidity regulator 110c and the air speed and air capacity regulator 110d are respectively controlled by a lighting control signal Lc, a temperature regulation control signal Hec, a humidity regulation control signal Huc and an air speed and air capacity regulation control signal Hsc.

(Nutrient Solution Circulation Section 130)

The nutrient solution circulation section 130 is provided with a nutrient solution tank 131 configured for storing a nutrient solution; a supply pipe 133 configured for supplying the nutrient solution of the nutrient solution tank 131 to the cultivation box 111 of the growth section 110; and a recycle pipe 132 configured for recycling the nutrient solution L of the cultivation box 111 to the nutrient solution tank 131. A part of the supply pipe 133 is equipped with a circulation pump 134 for circulating the nutrient solution L between the nutrient solution tank 131 and the cultivation box 111, which is configured to be controlled by a pump control signal Pc.

(Fertilizer Supply Section 120)

The fertilizer supply section 120 (supply unit) is configured for supplying three fertilizer solutions constituting the nutrient solution L to the nutrient solution tank 131 of the nutrient circulation section 130, and has the first to third supply tanks 121 to 123. In an illustrated embodiment, the nutrient solution is a solution obtained by mixing a nitric acid solution (the first fertilizer solution) L1, a phosphoric acid solution (the second fertilizer solution) L2, and a potassium chloride solution (the third fertilizer solution) L3 corresponding to nitrogen, phosphorus, and potassium as three elements of the fertilizer, but the present invention is not limited thereto.

The nitric acid solution L1 is stored in the first supply tank 121, the phosphoric acid solution L2 is stored in the second supply tank 122, and the potassium chloride solution L3 is stored in the third supply tank 123. The first to third supply pipes 21a-23a for supplying the corresponding fertilizer solution to the nutrient solution tank 131 are installed on the first to third supply tanks 121-123, respectively. Switching valves (the first to third switching valves) 21b-23b are provided on the first to third supply pipes 21a-23a respectively. Here, the first to third switching valves 21b-23b are configured to open and close the first to third supply pipes 21a-23a under the action of the first to third supply control signals Fc1-Fc3. Since the supply tanks 121-123 are cartridges and constructed in such a manner that they can be individually replaced, the supply tanks corresponding to the required ions can be easily replaced according to the remaining amount.

(Measurement Section 140)

The measurement section 140 comprises a measurement tank 141 for temporarily holding a nutrient solution L to be measured in concentration; first to third measurement electrodes 142a-142c disposed in the measurement tank 141; and a measuring instrument 145 configured for detecting a potential difference between the measurement electrodes 142a-142c and reference electrodes (not shown) respectively corresponding to the measurement electrodes. Here, the first measurement electrode 142a is an ion selective electrode that reacts only with nitric acid ions, the second measurement electrode 142b is an ion selective electrode that reacts only with phosphoric acid ions, and the third measurement electrode 142c is an ion selective electrode that reacts only with potassium ions. The measuring instrument 145 is configured for outputting information indicating respective concentration of nitrate ions, phosphate ions, and potassium ions in the nutrient solution L to the control section 150 based on the potential difference measured by the first to third measurement electrodes 142a-142c.

As described above, it should be noted that, in the present invention, in the case of what is referred to as “a measured value of ion concentration”, it refers to a value directly measured by a measurement unit of ion concentration, rather than a value indirectly derived from a measurement value of other ions by calculation or deduction, etc.

Further, the measurement tank 141 is connected to the nutrient solution tank 131 through an introduction pipe 43a on which a switching valve 43b is installed. A discharge pipe 44a for discharging the internal nutrient solution L is installed on the measurement tank 141, and the switching valve 44b is also installed on the discharge pipe 44a. These switch valves 43b and 44b are configured for opening and closing the introduction pipe 43a and the discharge pipe 44a under the action of an introduction control signal Sc and a discharge control signal Dc.

(Control Section 150)

The control section 150 may be a computer. In this embodiment, the computer 150 calculates the measured change in the concentration of the at least one ion (e.g., the amount and the rate of change for each prescribed period), and determines the cultivation stage of the plant, etc., based on the change in the ion concentration of the nitrate ion, the phosphate ion, and the potassium ion. According to this determination, the fertilizer supply section 120, the illumination instrument 110a, the temperature regulator 110b, the humidity regulator 110c, and the air speed and air capacity regulator 110d are controlled so that these devices become preset on/off states at various stages.

Here, the control section 150 controls the fertilizer supply section 120, the illumination instrument 110a, the temperature regulator 110b, the humidity regulator 110c, and the air speed and air capacity regulator 110d according to the change in the ion concentration, but is not limited to these, and may also control the growth environment (e.g., at least one of the fertilizer supply section 120, the illumination instrument 110a, the temperature regulator 110b, the humidity regulator 110c, and the air speed and air capacity regulator 110d) according to the measured change in the at least one ion concentration.

Further, the computer 150 controls the switching valves 21b, 22b, and 23b using the first to third supply control signals Fc1-Fc3 so as to open the first to third switching valves 21b, 22b, and 23b when the respective concentration of the nitrate ion, the phosphate ion, and the potassium ion are lower than a predetermined lower limit value. Thus, the fertilizer solution is supplied.

Further, the control section 150 controls the switching valve 43b using the introduction control signal Sc, so that the nutrient solution L is introduced from the nutrient solution tank 131 of the nutrient solution circulation section 130 to the measurement tank 141 of the measurement section 140, and further controls the switching valve 44b after measurement so as to discharge the nutrient solution L accumulated in the measurement tank 141.

Here, the computer 150 has a processor 151 that performs various operations based on a measurement signal Sd; an input/output interface (I/O IF) 153 that performs data exchange with equipment external to the computer; and a memory 152 that stores programs and various data that cause the processor 151 to operate.

(Determination and Control)

Hereinafter, an example of measurement of ion concentration and control of growth environment in the nutriculture system 100 of the present invention will be described.

In the nutrient solution measurement section 140, the measuring instrument 145 measures the concentrations of nitrate ions, phosphate ions, and potassium ions contained in the nutrient solution L accumulated in the measurement tank 141 by using the first to third measurement electrodes (ion selective electrodes) 142a to 142c under the action of a measurement control signal Moc from the computer 150, and outputs information indicating the concentration of the ions as a measurement signal Sd to the computer 150.

If the processor 151 receives the information indicating the ion concentration, a determination is made as to whether the ion concentration of any one of the nitric acid ions, the phosphoric acid ions, and the potassium ions is lower than a reference value.

The processor 151 determines the concentration of each ion in the nutrient solution and calculates its change (e.g., the amount and rate of change). The change is, for example, the amount or ratio of the change in the ion concentration of the present measurement relative to the ion concentration of the last measurement.

For example, the processor 151 may also be programmed for a reference value for each ion concentration change (e.g., a reference ratio for a reduction rate), determining in which cultivation stage the plant is based on the reference value, and controlling the environment forming unit or the supply ion concentration, etc., into which state in coordination with each cultivation stage.

Thereafter, the processor 151 compares the change rates of the respective ion concentration of the nitrate ions, the phosphate ions, and the potassium ions with the corresponding reference ratios to determine the cultivation stage of the plant 10.

The processor 151 may determine, after determining the cultivation stage of the plant 10, the event to drive the environment forming unit and/or the supply ions and their concentrations based on the control conditions of the respective devices (a fertilizer supply 120, an illumination instrument 110a, a temperature regulator 110b, and a humidity regulator 110c) of the environment forming unit set at the respective cultivation stages.

Thus, the cultivation stage of the plant is determined on the basis of the change of the ion concentration, and the environment forming unit and/or the supply ions are controlled according to the cultivation stage so as to be a proper environmental condition, thereby enabling efficient nutriculture with reduced waste of photothermal cost and the like accompanying the growth of the plant. For example, waste caused by irradiating the plant 10 with light when the plant 10 does not perform photosynthesis can be eliminated.

Thereafter, the processor 151 controls the switching valve 44b by using the discharge control signal Dc, so that the nutrient solution L is discharged from the measurement tank 141 to the outside of the nutriculture system 100 via the discharge pipe 44a.

For example, in the case where the ion concentration of any nutrient solution deviates from the range of the reference value, the processor 151 may adjust the ion concentration of the supply nutrient solution corresponding to the ion. For example, in the case where the ion concentration of the nitric acid ions is lower than the reference value, the processor 151 controls the first switching valve 21b by using the first supply control signal Fc1, so that the nitric acid solution is supplied from the first fertilizer solution L1 to the nutrient solution tank 131. Similarly, in the case where the ion concentration of the phosphate ions is lower than the reference value, the processor 151 controls the second switching valve 22b by using the second supply control signal Fc2, so that the phosphate solution is supplied from the second fertilizer solution L2 to the nutrient solution tank 131. Further, in the case where the ion concentration of potassium ions is lower than the reference value, the processor 151 controls the third switch valve 23b by using the third supply control signal Fc3, so that the potassium chloride solution is supplied from the third fertilizer solution L3 to the nutrient solution tank 131.

Further, in the present embodiment, in the ion concentration measurement section 140, the nutrient solution L is introduced from the nutrient solution tank 131 to the measurement tank 141, nitrate ions, phosphate ions, potassium ions are measured in the measurement tank 141, and the nutrient solution L is discarded after the measurement, so that it does not adversely affect the growth of the plant 10 even when constituent metals of the ion selective electrodes used as the first to third measurement electrodes are dissolved in the nutrient solution L.

However, there are also situations that not all of the various ion selective electrodes for determining various ions in the nutrient solution L are composed of substances adversely affecting the human body, but some of the electrodes have problems.

For example, the following situations may exist. Zinc phosphate is used in the ion selective electrode for selectively detecting the phosphate ions, dissolution of zinc into a nutrient solution L becomes a problem, and such dissolution of substances harmful to human body does not occur in other ion selective electrodes for selectively measuring the nitrate ions and the potassium ions.

In this case, if all the measurement electrodes for determining various ions in the nutrient solution are provided in one measurement tank 141, the capacity of the measurement tank 141 becomes large, which wastes a large amount of the nutrient solution L and is not economical.

Thus, it is also possible to use both the first and the second measurement tanks, the first measurement tank is provided with an ion selective electrode in which dissolution of harmful substances does not occur, the second measurement tank is provided with an ion selective electrode in which dissolution of harmful substances occurs, and the nutrient solution of the first measurement tank is returned to the nutrient chamber, while only the nutrient solution of the second measurement tank is discarded.

In this case, the amount of the discarded nutrient solution L can be reduced, and therefore the economy is good.

Further, the control of the supply unit, the illumination instrument, the temperature regulator, and the humidity regulator by the control section is not limited to the above-described embodiment.

As above, the present invention has been described using the preferred embodiment of the present invention as an example, but the present invention should not be construed as being limited to this embodiment. It should be understood that the scope of the invention should be construed only by the claims. It will be appreciated that those skilled in the art, on the basis of the record of the specific embodiment of the invention, will be able to implement an equivalent scope in combination with the record of the invention and technical knowledge. It should be understood that the contents of the literature cited in this specification are themselves incorporated into this specification by reference as if specifically set forth in this specification.

### INDUSTRIAL APPLICABILITY

According to the present invention, the growth environment of plants can be managed in coordination with the state of plants in the field of nutriculture systems. Therefore, it is useful as a nutriculture system capable of inhibiting the production cost to be low and efficiently producing high-quality vegetables and fruits.

### DESCRIPTION OF REFERENCE NUMERALS

100 nutriculture system

101 environment forming unit

110 growth section

120 fertilizer growth section

130 nutrient solution circulation section

131 nutrient solution tank

140 nutrient solution measurement unit

145 measuring instrument

L nutrient solution

1. A nutriculture system for cultivating plants by utilizing a nutrient solution, comprising:
a growth section configured for growing the plant;
a nutrient solution tank configured for containing the nutrient solution;
a measurement section configured for measuring the concentration of at least one ion contained in the nutrient solution;
a control section configured for controlling growth environment of the nutriculture system based on a change in a measured value of the ion concentration; and
a supply unit configured for supplying the ions to the nutrient solution tank.

2. The nutriculture system according to claim 1, wherein
the growth environment is selected from a concentration of the ions supplied by the supply unit, an amount of light irradiated to the plants, a temperature, an air speed, an air volume, and a humidity.

3. The nutriculture system according to claim 1, wherein
the control section controls an environment forming unit and/or the supply unit based on the measured amount or rate of change of concentration of the at least one ion over a prescribed period.

4. The nutriculture system according to claim 1, wherein
the at least one ion is a phosphorus ion.

5. The nutriculture system according to claim 1, wherein
the at least one ion further comprises at least one of potassium ions, nitrogen ions, calcium ions, magnesium ions, iron ions, sodium ions, chloride ions, tin ions and molybdenum ions.

6. The nutriculture system according to claim 1, wherein
the prescribed period is 10 minutes, 30 minutes, 1 hour, 2 hours, or 1 day.

7. The nutriculture system according to claim 1, wherein
the measurement section comprises:
a measurement tank configured for containing the nutrient solution taken out of the nutrient solution tank; and
one or more ion selective electrodes arranged in the measurement tank and configured for respectively reacting with the at least one ion.

8. The nutriculture system according to claim 7, wherein
all or part of the nutrient solution contained in the measurement tank is not returned to the nutrient solution tank, but is discarded.

9. The nutriculture system according to claim 6, wherein
a measurement tank is provided separately for each of the at least one ion to be measured.

10. The nutriculture system according to claim 6, wherein
the at least one ion selective electrode comprises at least zinc phosphate selectively reacting with the phosphorus ions contained in the nutrient solution.

11. The nutriculture system according to claim 6, wherein
the at least one ion selective electrode is a cartridge.

12. The nutriculture system according to claim 1, wherein
the supply unit is provided with at least one supply tank separately containing the at least one ion.

13. The nutriculture system according to claim 1, wherein
the system further comprises a circulation section configured for circulating the nutrient solution between the plant and the nutrient solution tank.

14. The nutriculture system according to claim 12, wherein
the at least one supply tank is a cartridge.

15. A manufacturing method for cultivating plants by a nutrient solution, characterized by comprising:
a process for cultivating the plants using the nutriculture system according to claim 1.
